(19) United States
(12) Patent Application Publication
(10) Pub. No.: US 2010/0270846 A1
(43) Pub. Date: Oct. 28, 2010

(54) SEATING

(76) Inventors: Sylvain Gleyal, Molsheim Cedex (FR); Gerald Bugli, Molsheim Cedex (FR); Francois Cortal, Molsheim Cedex (FR)

Correspondence Address: OHLANDT, GREELEY, RUGGIERO & PERLE, LLP, ONE LANDMARK SQUARE, 10TH FLOOR, STAMFORD, CT, 06901, US

(21) Appl. No.: 12/669,730

(22) PCT Filed: Jul. 16, 2008
(86) PCT No.: PCT/EP08/05788

§ 371 Date: Jun. 29, 2010

(30) Foreign Application Priority Data
Jul. 20, 2007 (GB) 0714221.9
May 20, 2008 (GB) 0809137.3

(51) Int. Cl. B60N 2/68; A47C 7/02; A47C 7/16; B60R 22/00

(52) U.S. Cl. 297/452.18

(57) ABSTRACT

Vehicle seat frames of increased strength at constant or lighter weight are provided by including a foam reinforcement within the hollow sections that make up the seat frame. The foam may be provided on a carrier which can be designed to provide additional reinforcement to the seat frame.

The present invention relates to improvements in or relating to seating and in particular to seating that is used in moving environments where protection against crash and/or changes in velocity is required. The invention is particularly useful in seating used in transportation such as in automobiles including passenger cars, trucks and busses and in trains and aircraft.

Seating, particularly for use in automobiles is frequently based on a hollow metal frame consisting of tubular sections, box sections, or open sections such as U, C, I, G, W or other shaped sections which are made from stampings that are welded together. The frames are designed so that they can carry accessories such as a tilting mechanism, a mechanism for moving the seat backwards and forwards, heating and cooling elements and the associated electronics. The frames are also designed so that they can carry the various seating and cushioning materials that may be required and the frame is also provided with means whereby the seat may be positioned and secured within the vehicle.

Seats are required to be safe and to provide protection for the occupant during operation of the vehicle. In particular the seats are required to protect the occupant during acceleration and deceleration of the vehicle which can be repeated. In particular the seat is required to protect the occupant in the event of a crash. For example, the seat back of the back seat should provide protection against luggage which may be thrown against the back of the seat from the vehicle boot or luggage storage compartment in the event of a crash. Equally the back of the front seat needs to provide protection against impact from the rear as well as ensuring adequate security from the seat belts in the event of a crash. The strength requirements of seats are more and more being governed by regulations. The majority of the strength of the seat is provided by the metal frame. As the strength requirements have been increased the metal frames have been made of thicker metal and/or speciality high strength metals which have weight and/or cost debits.

In a further development of seats seat belts, rear and front seats, are at times being connected to the frame of the seat rather than to the pillar of the vehicle (such as the B and C pillar). This concept allows the same or similar seats to be used in different size and shaped vehicles and avoids the need to design and develop a unique seat for each vehicle. However this imposes an additional need to increase the strength of the frame to be able to take the strain exerted on the seat belt during a crash.

These developments are all taking place at a time when there is a general requirement to reduce the weight of vehicles to lower fuel consumption and reduce environmental pollution and the seats are a significant weight component in the vehicle.

The present invention provides a solution to these challenges, furthermore the invention can provide an improved method for assembling the various components of the seat.

The present invention therefore provides a seat frame comprising hollow sections reinforced with foam. The seat frame consists of any of the sections which support the other elements of the seat such as the cushioning, electronics, seat belts and the like. The sections may be closed or may be open sections such as U, C, W, W or other shaped sections. The invention further provides a seat based on such a frame.

In a preferred embodiment the foam is formed in situ within the hollow section or sections. A foamable material such as for example two components which react on mixing can be pumped into the hollow section may be used. Alternatively the foam may be introduced in the unfoamed state and subsequently foamed to fill the cross section of the hollow section of the seat frame. As a further alternative the unfoamable material may be introduced into the hollow section on a carrier and foamed to fill the gap between the carrier and the inner surface of the hollow section. In this preferred embodiment the carrier may be designed to provide additional strength to the seat frame.

Any material that can be foamed to provide a reinforcing effect to the seat frame may be used. In the manufacture of automobile seats some or all of the frame is usually metal and is typically subject to an electrocoat anticorrosion coating and to a painting prior to the provision of the cushioning, the electronics and other seating components. It is convenient therefore to use a foamable material that will foam under the conditions that are employed in the anticorrosion and/or painting processes and given that both these processes involve a heating step to bake the coating, the foamable material is preferably heat activated and formulated so that it will expand at the baking temperatures. In this way the reinforcement can be provided without requiring any additional fabrication steps in the production of the seat frame. In this respect the provision of the reinforcement is somewhat similar to the provision of structural reinforcement within the hollow sections of vehicle body frames.

In a preferred embodiment the reinforcement is provided by a core material carrying a foamable material on some or all of its exterior surface and the core material is designed to provide reinforcement to the seat frame. The foamable material is heat activated and it is preferred that when it is activated it develops adhesive properties and as it expands and bonds the carrier to the internal surface of the hollow component(s) of the seat frame. Preferred foamable materials are epoxy based foamable materials such as those supplied by L & L Products Inc under the designation L5206, L5207, L5208 and L5209. Alternatively foamable polyurethanes and other high strength materials may be used. The product should be chosen so that it softens and becomes adhesive at temperatures below that at which it foams and according to the rate of expansion and foam densities required. It is further preferred that it expand at the temperatures experienced in the oven used to dry and cure the anticorrosion coating deposited in the electrocoat process, or to bake a paint coating such as an epoxy paint, typically 80° C. to 220° C., more typically 110° C. to 185° C., most typically 130° C. to 150° C.

If the mouldings are of complex structure and the need is to provide foam at only certain locations on the carrier we have found it useful to adopt certain techniques to guide the foaming. We have found it useful to provide ribs in the carrier which help to direct the direction of expansion of the foamable material as it foams. Such a technique is described in United Kingdom Patent Publication GB 2375328 A and is useful in that it helps confine the foam to the areas where it is required so economising on the amount of foamable material required.

The reinforcing members may be provided with means whereby they can be placed and retained in the appropriate location in the seat frame. In many instances the reinforcing members are placed in the seat by robots and the members are therefore preferably provided with locator means to enable the robot to locate the member and lift it and place it in the seat structure. The locator means may comprise locations such as holes in the member which can be located by sensors on the robot. In addition the member can be provided with extensions which enable the robot to pick up the member and transfer it to the appropriate location in the seat metal frame structure. The manner by which the member is retained within the seat frame structure depends upon the position of the part within the structure and if it is provided to a horizontal or inclined element of the seat frame structure. If the member is provided to lie horizontally within the metal structure it may be provided with tabs which enable it to rest on the metal structure. In other environments clips or other forms of attachment may be required. Alternatively it may be in place due to the effect of gravity.

It is important that when the electrocoat anticorrosion fluid which is applied prior to foaming can flow through the hollow structures of the seat when the metal structure containing one or more reinforcing members passes through the bath of the fluid. Accordingly it may be necessary to provide channels in the reinforcing member to enable flow of the electrocoat fluid. Furthermore it may be necessary to ensure provision of an adequate gap between the foamable material and the metal for flow of the electrocoat fluid. Such a gap may be provided by an appropriate means of attachment or spaces such as is illustrated in Japanese Patent Application 7-117728 sections of the seat frame. Alternatively or additionally the structural reinforcing member may be provided with small lugs, which enable it to stand away from the interior walls of the hollow structure. In this way fastening devices may not be required and the area of contact between the structural reinforcing member and the interior walls of the frame of the vehicle is minimised.

In this preferred embodiment where the foamable material is provided on a carrier the carrier material may be of metal or plastic. Where it is of metal it may be made by stamping or hydroforming, where it is of plastic it may be produced by extrusion, injection moulding or blow moulding. In a particularly preferred embodiment the carrier is made from reinforced thermoplastics such as fibre filled nylon or polypropylene and is formed by injection moulding, glass filled nylon is particularly useful. The carrier can be moulded to a size and shape to suit the contours of the hollow section of the seat frame that is to be reinforced. The carrier may also be a ribbed structure containing internal or external ribs designed to provide additional reinforcement to the frame. Ice tray type configurations are particularly useful.

The reinforcement may be provided at any position of the seat frame where additional strength and/or weight saving is required, the position can depend upon the design of the vehicle. We prefer however to provide reinforcement in the upper transverse (in the location in the vehicle) section of the frame and in particular at the locations where there are bends in the frame as it extends from the transverse section to the vertical section. These are the regions in the seat frame that take the greatest stress due to acceleration and deceleration of the vehicle and are also the sections that are prone to buckling when a vehicle is involved in a front crash. In another embodiment the reinforcement is provided down one or both of the sides of the seat frame. Rear seats often have a metal panel as backing for the seat and in larger vehicles provided with rear seats that can accommodate three or more passengers such as a bench seat the seat back may comprise several panels constructed from welded sections. Reinforcement can be provided within such panels to provide strength against impacts against the back of the seat. The present invention is particularly useful to provide reinforcement to the central transverse element of the bench seat since seat belts are often secured to the central transverse element. The reinforcement can also be provided at the position where a head rest is joined to the seat frame.

In a particular embodiment where the seat belt is mounted on the seat frame and is not attached to the main body of the vehicle, we prefer that reinforcement be provided at one, two or all of the locations where the seat belt is attached to the seat frame.

We have found that implementation of the present invention in the upper transverse section of the seat frame can provide a seat of comparable weight to an all steel frame in which the upper section is able to absorb up to 70% more energy prior to buckling. We have also found that by use of the invention an upper section with the same buckling energy can be produced with a 30% weight saving. The invention therefore provides improved economics in seat manufacture materials, and also provides improved crash performance in that it provides a stiffer structure with less fatigue. The invention can also simplify the assembly of a seat particularly the seat frame as the foamable material can also act as a structural adhesive to bond components of the seat together. The material can be used to bond meta components together thus reducing or eliminating the need for welding which has considerable economic and technical benefits. The manufacturing process is easy in that the reinforcement may be provided in the seat frame during assembly of the hollow sections. Furthermore, in the embodiment of the invention where the seat belt is anchored to the seat frame, the design options are significantly increased and the ability is provided to use a single basic seat design in a range of vehicles.

The present invention is illustrated by reference to the accompanying drawings in which

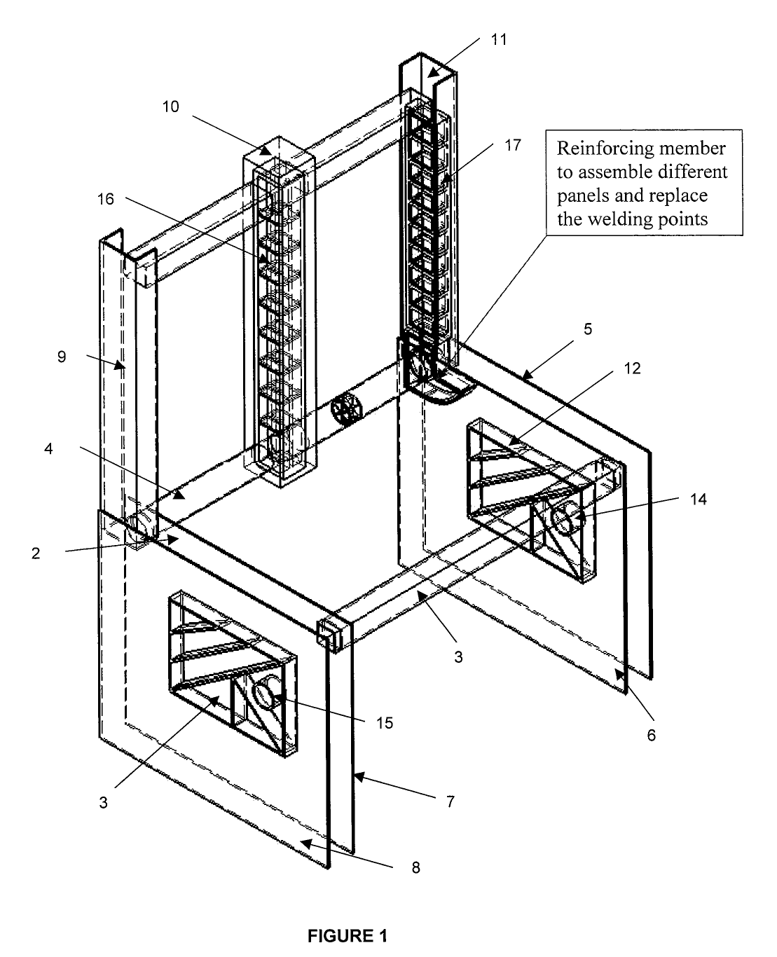

FIG. 1 is a schematic illustration of a seat frame showing reinforcement provided at various different positions around the frame.

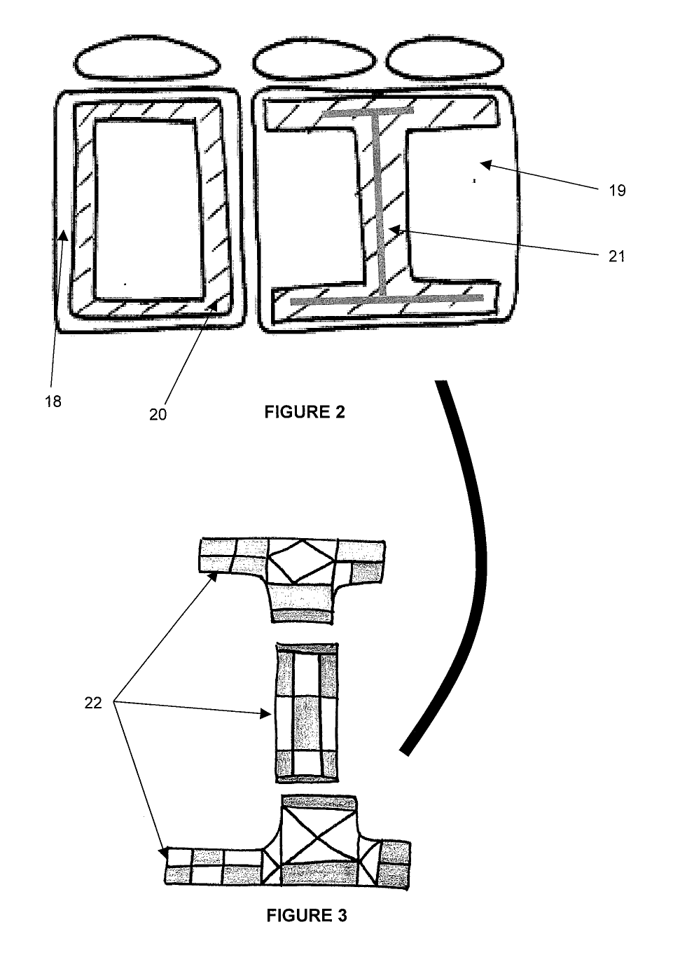

FIG. 2 shows the back of a back seat of a vehicle and FIG. 3 shows the reinforcement that can be inserted into FIG. 2 as shown.

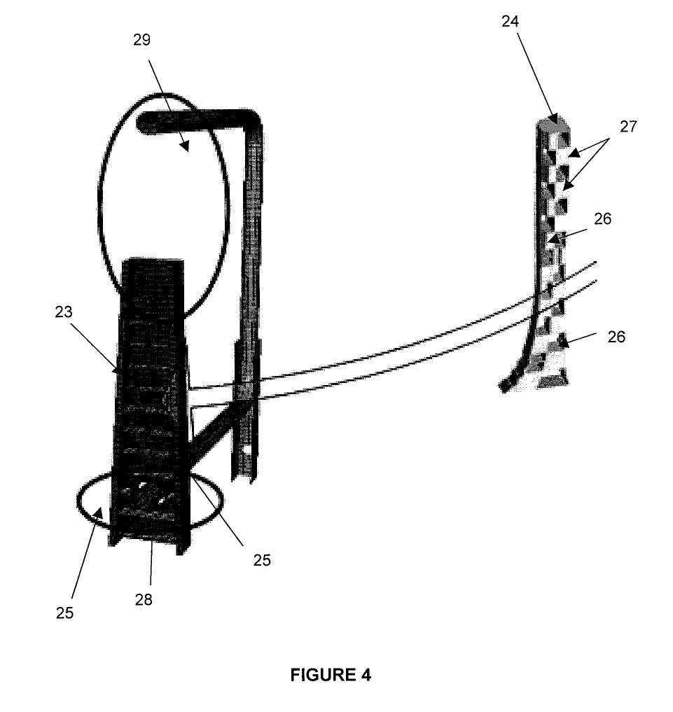

FIG. 4 shows how reinforcement can be provided in the side of a seat frame.

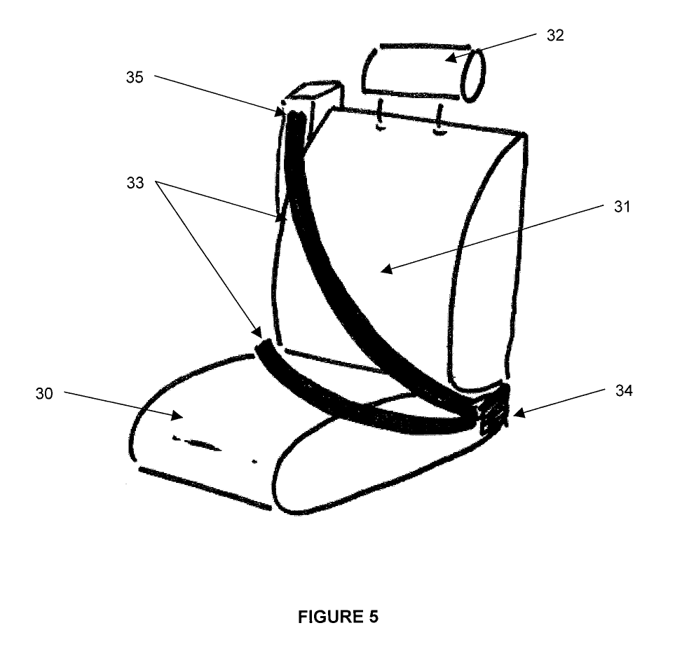

FIG. 5 shows a seat with reinforcement at the seat belt anchoring positions.

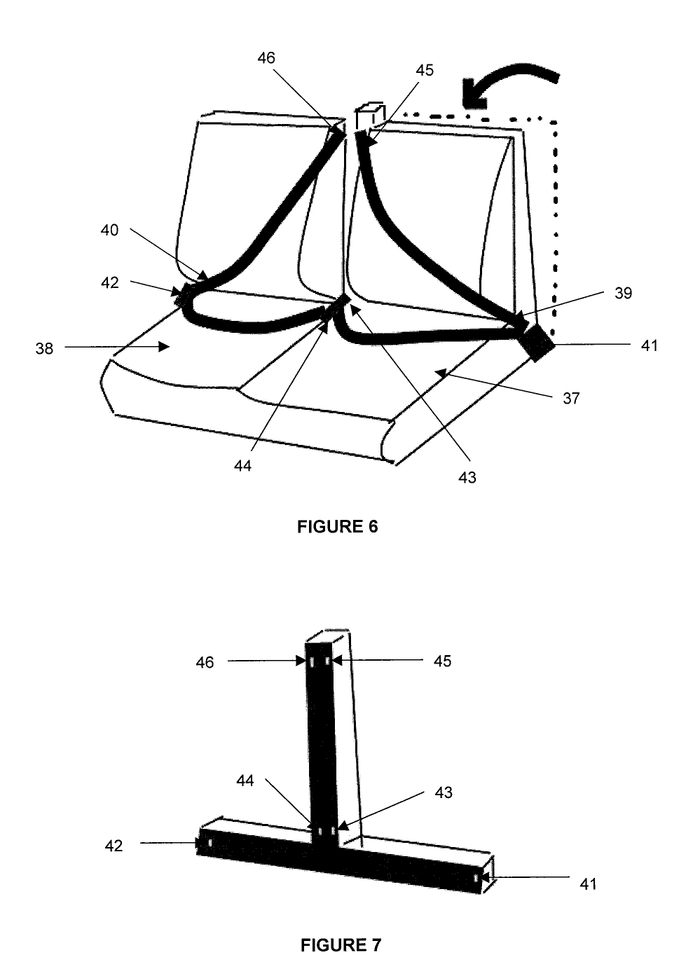

FIG. 6 shows a bench seat with seat belts attached.

FIG. 7 shows the central transverse element of the bench seat shown in FIG. 6.

FIG. 1 shows a seat frame comprising two side portions of the base (1) and (2) joined by cross members (3) and (4). Each side portion consists of two panels (5), (6) and (7), (8). The back support frame has three pillars (9), (10) and (11). As shown the sections are hollow and are strengthened by the inclusion of reinforcing members (12) and (13) in the locations in the base portions (10) and (11) of seat belt attachment points (14) and (15). The back section pillars (10) and (11) are also provided with reinforcements (16) and (17). The reinforcement at (17) can provide strength at the upper point of attachment of the seat belt.

FIG. 2 is a schematic illustration of the back panel of a rear seat consisting of two metal panels (18) and (19) containing hollow sections (20) and (21). FIG. 3 shows a reinforcing component (22) which can be inserted into the hollow cavity of panel (19) shows a reinforcement provided in panel (23).

FIG. 4 shows the side (22) of a seat frame supporting the back of a seat together with a reinforcing element (23) which can be inserted into the U shaped side member of the seat (24). The reinforcing member has an ice tray type carrier structure comprising ribs (25) and areas covered with foamable material (26). The material can be foamed to bond the carrier to the side member and provide reinforcement for example at the seat belt attachment areas (27) and (28).

FIG. 5 shows a finished seat with cushion (29), back (30) and head rest (31) showing also the provision of the seat belt (32) with reinforcement (33) and (34) provided at the location of the seat belt attachments.

FIG. 6 shows a bench seat (36) comprising two seating positions (37) and (38) and diagrammatically illustrating the seat belts (39) and (40) and their attachment to the frame at edge positions (41) and (42) and at the lower centre (43) and (44) and the upper centre (45) and (46).

FIG. 7 shows the central transverse employed but not shown in the seat shown in FIG. 6 showing the positions (41), (42), (43), (44), (45) and (46) for the seat belt attachments. The present invention is particularly suited for the provision of reinforcement at one or more of these positions.

1. A seat frame comprising hollow sections reinforced with foam.

2. A seat frame according to claim 1 which is a seat frame for an automobile, a truck or a bus.

3. A seat frame according to claim 1 in which the foam is formed in situ within the hollow section or sections.

4. A seat frame according to claim 1 in which the reinforcement is provided by a carrier material carrying a foamable material on some or all of its exterior surface and the core material is designed to provide additional reinforcement to the seat frame.

5. A seat frame according to claim in which the foamable material is an epoxy based foamable material.

6. A seat frame according to claim 1 in which the foamable material softens and becomes adhesive at temperatures below that at which it foams.

7. A seat frame according to claim 1 in which the foamable material expands at the temperatures experienced in the oven used to dry and cure an anticorrosion coating deposited in the electrocoat process or paint bake process.

8. A seat frame according to claim 1 in which the reinforcing members is provided with means whereby they can be placed and retained in the appropriate location in the seat frame.

9. A seat frame according to claim 8 in which the means comprises clips.

10. A seat frame according to claim in which the carrier material is of metal or plastic.

11. A seat frame according to claim 10 in which the carrier is of metal and is made by stamping or hydroforming.

12. A seat frame according to claim 10 in which the carrier is of plastic and is produced by extrusion, injection moulding or blow moulding.

13. A seat frame according to claim 4 in which the carrier has a ribbed structure containing internal or external ribs.

14. A seat frame according to claim 13 in which the ribs are designed to provide additional reinforcement to the frame.

15. A seat frame according to claim 1 in which the reinforcement is provided in the upper transverse (in the location in the vehicle) section of the frame.

16. A seat frame according to claim 1 in which the reinforcement is provided down one or both of the sides of the seat frame.

17. A seat frame according to claim 1 in which the reinforcement is provided in the base support.

18. A seat frame according to claim 1 in which the reinforcement is provided in the back rest support.

19. A seat frame according to claim 1 in which a seat belt is mounted on the seat frame and reinforcement is provided at one, two or all of the locations where the seat belt is attached to the seat frame.

20. A seat frame according to claim 1 in which the reinforcement is provided in hollow sections in the back of the seat.

21. A seat frame according to claim 20 in which the reinforcement is provided in the central transverse.

22. A seat frame according to claim 1 in which the reinforcement is provided in the fixing area of the head rest.

23. A seat based on a seat frame according to claim 1.

24. A rear seat for a vehicle containing a seat frame according to claim 1.
